(19) United States
(12) Patent Application Publication
(10) Pub. No.: US 2014/0029877 A1
(43) Pub. Date: Jan. 30, 2014

(54) SHAFT AND BEARING ARRANGEMENT AND HYDROSTATIC SPINDLE FOR HIGH SPEED APPLICATIONS

(71) Applicants: Leonid Kashchenevsky, Plainville, CT (US); Yuri Lysov, Vilnius (LT)

(72) Inventors: Leonid Kashchenevsky, Plainville, CT (US); Yuri Lysov, Vilnius (LT)

(21) Appl. No.: 13/737,651

(22) Filed: Jan. 9, 2013

Related U.S. Application Data
(60) Provisional application No. 61/584,525, filed on Jan. 9, 2012.

(51) Int. Cl. F16C 32/06

(52) U.S. Cl. CPC F16C 32/064
USPC 384/107

(57) ABSTRACT

A spindle includes a housing, a shaft rotatably mounted to the housing, a first bearing arrangement and a second bearing arrangement. The first bearing arrangement has at least one first pocket defined between the first bearing arrangement and the shaft forming a first radial hydrostatic bearing and a longitudinal recess between the first bearing arrangement and the shaft forming a first portion of a thrust hydrostatic bearing. Fluid supplied to the first portion of the thrust hydrostatic bearing is supplied thereto from the at least one first pocket directly through a first radial gap defined between the first bearing arrangement and the shaft. The second bearing arrangement has a longitudinal chamber between the second bearing arrangement and the shaft forming a second portion of the thrust hydrostatic bearing. Longitudinal forces on the shaft from the first portion of the thrust longitudinal bearing and the second portion of the thrust longitudinal bearing are in opposing directions.

### CROSS REFERENCE TO RELATED APPLICATION

This application claims priority to U.S. provisional application, 61/584,525, filed Jan. 9, 2012, the entire contents of which are incorporated herein by reference.

### BACKGROUND

Hydrostatic spindles are one of the most precise types of spindle. They uniquely combine ultra-high rotational accuracy, high static stiffness, extremely high vibration resistance, high thermal stability with virtually limitless lifespan.

In comparison to spindles with ball bearings or roller bearings, hydrostatic spindles have 10 to 20 times greater rotational accuracy at low and medium speeds range, and 20 to 40 times greater rotational accuracy at high rotational speeds.

Additionally, in comparison to spindles with air-static bearings, hydrostatic spindles have about the same rotational accuracy, while their vibration resistance, load capacity and thermal stability are significantly greater. The vibration resistance of hydrostatic spindles is greater because oil used in the bearing is virtually incompressible and its viscosity is orders of magnitude greater than the viscosity of air. The higher supply pressures employable in hydrostatic spindles allows for greater static stiffness and high load capacities. To reach the same load capacity as that of a hydrostatic spindle, an air-static spindle would need to have recessed surfaces that are 10 to 15 times larger than the hydrostatic spindle. Also, by using circulated chilled oil with precisely controlled temperatures a hydrostatic spindle achieves excellent thermal stability.

The combination of aforementioned advantages of hydrostatic spindles are especially critical in high speed applications. The excellent resistance to vibration that allows hydrostatic bearings to remain contact-less make the performance of hydrostatic spindles less sensitive to unbalanced forces when compared to ball bearing spindles and to air-static bearing spindles.

By employing chillers to the circulated oil, heat generated by the rotor of an integrated motor can be removed in a much more efficient manner than possible with other types of high speed spindles. Heat generated by rotors is of primary concern since it can cause parts such as shafts to thermally expand in relation to bearings which can ultimately cause failure of bearing in a spindle.

There are, however, some issues that significantly restrict use of hydrostatic spindles in applications with high rotational speeds. One such issue is shear friction in the bearings. Power consumed by shear friction increases in proportional to the square of the speed for laminar portions of friction, and increases at an even greater rate for turbulent portions. Reducing the viscosity of the oil helps to a certain extent only. However, while lowering oil viscosity reduces the laminar component of the friction power it actually results in an increase in the turbulent component. Using lower oil viscosity also results in an increase in oil flow that will result in a proportionally increase in pumping power. Additionally, oil flow rates that are too great will result in oil leakage.

The art is therefore always receptive to systems and methods to alleviate the foregoing concerns.

### BRIEF DESCRIPTION

Disclosed herein is a spindle. The spindle includes a housing, a shaft rotatably mounted to the housing, a first bearing arrangement and a second bearing arrangement. The first bearing arrangement has at least one first pocket defined between the first bearing arrangement and the shaft forming a first radial hydrostatic bearing and a longitudinal recess between the first bearing arrangement and the shaft forming a first portion of a thrust hydrostatic bearing. Fluid supplied to the first portion of the thrust hydrostatic bearing is supplied thereto from the at least one first pocket directly through a first radial gap defined between the first bearing arrangement and the shaft. The second bearing arrangement has a longitudinal chamber between the second bearing arrangement and the shaft forming a second portion of the thrust hydrostatic bearing. Longitudinal forces on the shaft from the first portion of the thrust longitudinal bearing and the second portion of the thrust longitudinal bearing are in opposing directions.

Further disclosed herein is a shaft and bearing arrangement. The arrangement includes a housing, a shaft rotatably engaged with the housing, a first ring attached to the housing and a second ring attached to the housing. The first ring is configured to support the shaft in a first longitudinal direction and in radial directions via fluid positioned between the first ring and the shaft. The second ring is configured to support the shaft in a second longitudinal direction via fluid positioned between the second ring and the shaft

### BRIEF DESCRIPTION OF THE DRAWINGS

FIG. 1 depicts a cross sectional view of a spindle disclosed herein.

FIG. 2 depicts a cross sectional view of an alternate embodiment of a spindle disclosed herein;

FIG. 3 depicts a side view of a bearing ring employed in FIG. 1;

FIG. 4 depicts a cross sectional view of the bearing ring of FIG. 3 taken at arrows B-B; and

FIG. 5 depicts a cross sectional view of the bearing ring of FIG. 4 taken at Arrows A-A.

### DETAILED DESCRIPTION

A detailed description of one or more embodiments of the disclosed apparatus and method are presented herein by way of exemplification and not limitation with reference to the Figure.

With hydrostatic bearings, friction power is extremely sensitive to the sizes of the bearing. Friction power is proportional to a cube of the bearing diameter in laminar flows, and grows at an even faster rate for turbulent flows. Since the instant invention is directed to spindles with high rotational speeds, small spindle shaft diameters are employed. Also, a reduction in a diameter of a journal bearing will nearly proportionally reduce the hydrostatic support stiffness. Additionally, since shaft bending stiffness is proportional to a fourth power of the shaft diameter it is reduced even more. Reliability issues and the ability of hydrostatic spindles to withstand overloading conditions are more critical for applications with high rotational speeds than it is for applications with low and medium rotational speeds. The high speed hydrostatic spindles disclosed herein allow for a significant reduction in frictional power, while being more robust. They also allow for a reduction in thermal expansion thereby making the spindle less costly and easier to manufacture.

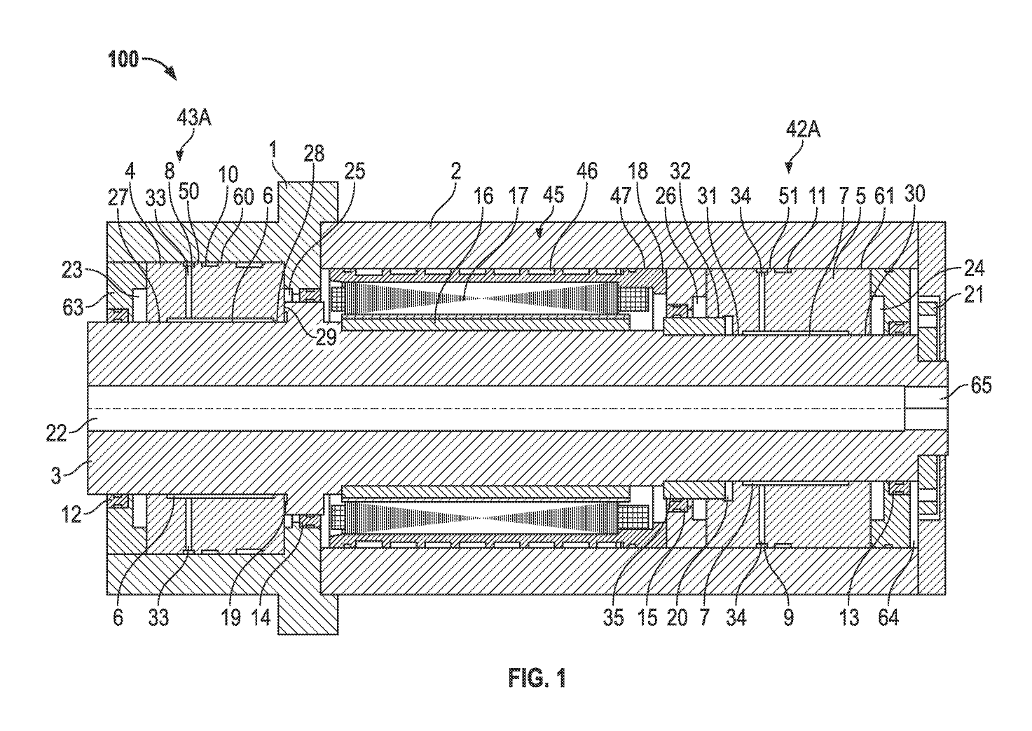

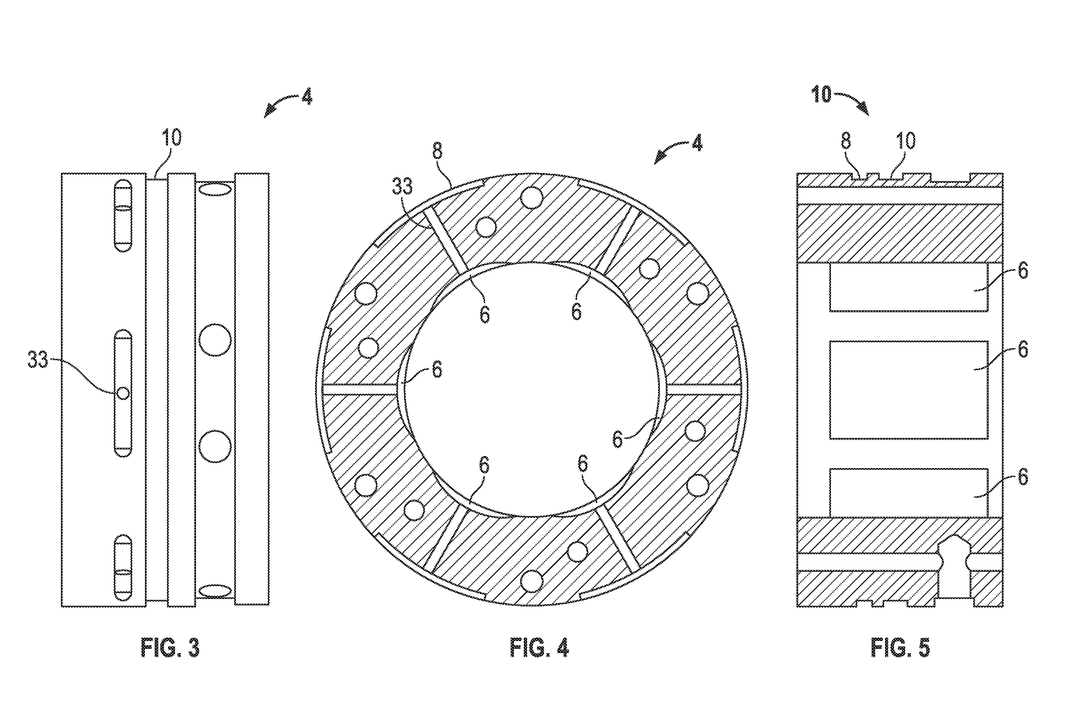

Referring to FIGS. 1, 3, 4 and 5, a spindle disclosed herein is illustrated at 100A. The spindle 100A includes, a two-piece spindle housing consisting of, a front housing 1 and a rear housing 2. A front bearing arrangement 43A supports a shaft 3 relative to the front housing 1, and a rear bearing arrangement 42A supports the shaft 3 relative to the rear housing 2. The shaft 3 is rotatably supported in radial directions by at least one pocket 6 of the front bearing arrangement 43A and by at least one pocket 7 of the rear bearing arrangement 42A with a plurality of the pockets 6 and 7 being illustrated in this embodiment. The supporting pockets 6 and 7 are formed in inner radial surfaces of a front bearing ring 4 and a rear bearing ring 5, respectively. See FIGS. 3-5 for details of an embodiment of the bearing ring 4 employing six of the pockets 6. In embodiments herein the bearing rings 4 and 5 are each made of a single piece of material such as metal, for example. In axial directions the shaft 3 is supported by a thrust bearing defined by a longitudinal recess 19 and a preloading chamber 20. The longitudinal recess 19 is loaded by fluid pressure supplied to the preloading chamber 20.

An electrical motor 45 employed to rotate the shaft 3 is located between front and rear bearing arrangements 43A and 42A. Locating the motor 45 between front and rear bearing arrangements 43A and 42A provides higher stability for higher rotational speed ranges than systems that employ motors located longitudinally beyond either of the front and rear bearing arrangements 43A and 42A. The motor 45 includes a rotor 16, a stator 17 and a cooling jacket 18. In this embodiment the rotor 16 is mounted on the shaft 3 via press fit and the stator 17 is mounted by press fit into the cooling jacket 18. The cooling jacket 18 is mounted to the housing 2 and contains a spiral groove 46 in its external surface 47 through which chilled liquid can flow to cool the stator 17.

External surfaces of the bearing rings 4 and 5 include annular grooves 10 and 11, and sets of primary recesses 8 and 9. The number of primary recesses 8 and 9 are equal to the number of main pockets 6 and 7. Every primary recess 8 and 9 is connected by means of ports 33 and 34 (see FIGS. 3, 4 and 5) to the corresponding main pockets 6 and 7. A small radial gap 50 exists between the annular groove 10 and the primary pockets 6 for a front journal bearing 60, and a small radial gap 51 exists between the annular groove 11 and the primary pockets 7 for a rear journal bearing 61. The radial gaps 50, 51 serve as inlet restrictors to provide positive values for radial and tilting stiffness. To maximize the stiffness value the sizes for the radial gaps 50, 51 (length and radial clearance) need to be within a certain range. The clearances in the radial gaps 50, 51 between annular grooves 10 and 11 and primary recesses 8 and 9 are consequently made smaller compared to the clearances in other radial gaps for the front and rear journal bearings 60, 61. As such, these other radial gaps will perform as “last chance” filters in addition to filters in an inlet high pressure line (not shown), thereby preventing contamination and subsequent damage that could occur should contamination be permitted to reach hydrostatic bearings of the front or rear bearing arrangements 43A, 42A.

From the pockets 6 of the front journal bearing 60 fluid such as oil, for example, moves to a return line longitudinal chamber 23 through a radial gap 27. Fluid also moves from the pockets 6 in an opposing direction to the longitudinal recess 19 through a radial gap 28. Additionally, fluid also moves from the longitudinal recess 19 to a return line chamber 25 through a thrust gap 29.

Similarly, from the pockets 7 of the rear journal bearing 61 fluid moves to a return line annular chamber 24 through a radial gap 30. Fluid also moves from the pockets 7 to the longitudinal preloading chamber 20 through a radial gap 31. From the preloading chamber 20, oil moves to a return line chamber 26 through a radial gap 32.

Oil pressure in the preloading chamber 20 does not depend upon axial position of the shaft 3 and, therefore, a constant preloading force is directed against the longitudinal recess 19. Oil pressure in the longitudinal recess 19 changes quickly depending upon the axial position of the shaft 3 and, therefore, axial stiffness is generated.

There are four air sealing rings 12, 13, 14 and 15. The air sealing rings 12 and 13 are located at a front flange 63 and a rear flange 64 of the shaft 3. The air sealing rings 14 and 15 are located on opposing sides of the built in motor 45. Pressurized air is supplied to annular grooves on an internal surface of the air sealing rings 12, 13, 14 and 15. Elevated air pressure in the air sealing rings 12 and 13 prevents leakage, pushes oil back to a tank and keeps the bearings 19, 20, 60 and 61 clean by preventing contamination from reaching them. Additionally, elevated air pressure in the air sealing rings 14 and 15 keeps the motor 45 free from oil.

The gaps in the air sealing rings 12 and 13 are smaller than the radial gaps 27, 30 in the front and rear journal bearings 60, 61. In case of radial overloading the front and rear journal bearings 60, 61 will be not damaged because shaft 3 will touch internal surfaces of the air sealing rings 12, 13 before it will touch the bearing surfaces. In this embodiment, to minimize possible damage to the shaft 3, the air sealing rings 12, 13, 14, 15 are made of low friction bronze (possibly the same type of bronze used for hydrodynamic bearings), for example. The air sealing rings 12, 13, 14, 15 are smaller and less complex than the bearing rings 4, 5 and are therefore cheaper to fabricate. Additionally, replacement of the air sealing rings 12, 13, 14, 15 in the foregoing structure is cheaper, simpler and takes less time than would be required to replace the bearing rings 4, 5.

The gaps in air sealing rings 14 and 15 are made small to prevent oil passage thereby yet are large enough to avoid spindle damage due to thermal expansion of the shaft 3 at locations close to the rotor 16.

Additionally, the shaft 3 can be moved a relatively large distance (compared to the initial axial gap) before potentially damaging contact is made in response to overloading in axial directions.

To achieve near optimal stiffness of both the journal bearings 60, 61 and the thrust bearings 19, 20 the outlet radial gap 27 (between the pockets 6 of the front journal bearing 60 and the longitudinal chamber 23) should be longitudinally about twice as long as the outlet gap 28 (between the pockets 6 of the front journal bearing 60 and the recess 19). Similarly, the outlet radial gap 30 (between the pockets 7 of the rear journal bearing 61 and the return line annular chamber 24) should also be longitudinally about twice as long as the outlet gap 31 (between the pockets 7 of the preload chamber 20). A longer radial gap generates higher hydrodynamic forces (these forces are approximately proportional to the third power of the length of the gap). Maintaining the radial gaps 30 and 31, located nearer to front and rear ends of the shaft 3 respectively, at long values will increase resistance to overloading the spindle 100A thereby improving reliability.

Because the journal bearings 60, 61 and thrust bearings 19, 20 are combined in embodiments herein, the total friction power and the total flow rate for the front and rear bearing arrangements 43A, 42A will be substantially the same as for one set of two journal bearings. Additionally, the thrust hydrostatic bearings 19, 20 will avoid generating additional flow and friction in contrast to typical spindles that have independent thrust and journal bearings.

Also, since the thrust bearings 19, 20 disclosed herein require no additional inlet restrictors there are no special requirements needed to adjust axial gaps and manufacturing and assembling of the disclosed spindle 100A is easier and faster than for typical spindles.

In the embodiments disclosed, a bushing 35 is mounted via press fit to the shaft 3 thereby allowing simplification of choosing of an optimal size of the preload chamber 20 to keep axial stiffness close to an optimal value. Simultaneously, a portion of an external surface of the bushing 35 can be used for material removal during balancing of the shaft 3 in two planes on a balancing machine.

A rotary encoder 21 can be employed using closed loop feedback to effectively control speed of the shaft 3 and current of the motor 45.

A through-hole 22 in the rotating shaft 3 can be employed to supply coolant therethrough. Additionally, such supply coolant can be used to pressurize passages to, for example, control a chuck or other tool that could be mounted near one end of the shaft 3. A thread 65 in a portion of the through-hole 22 can be used to mount other devices, such as a multi-passages rotary union, for example, to the shaft 3.

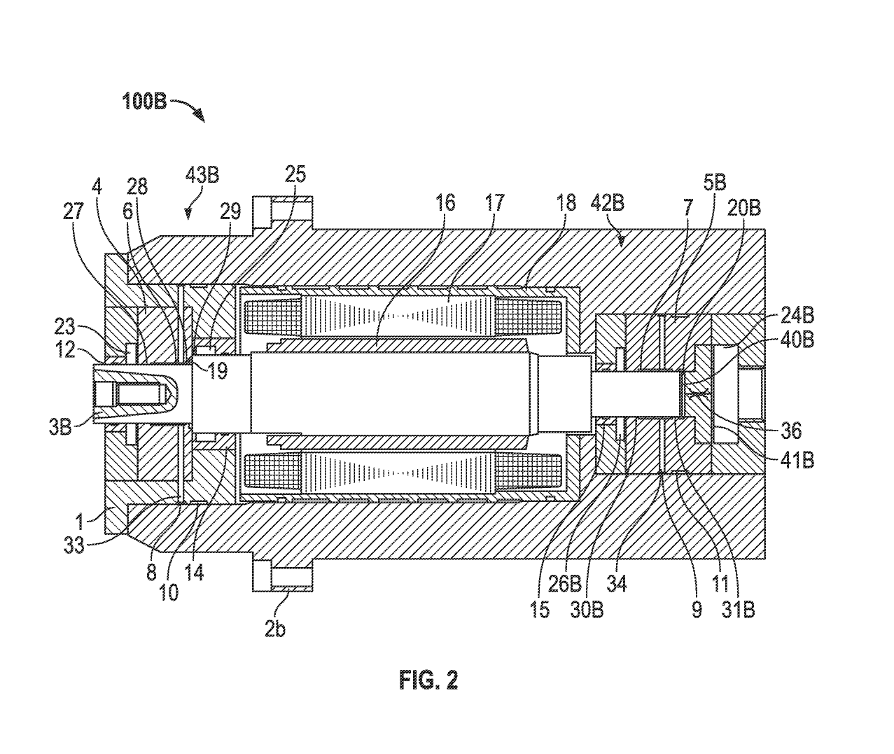

Referring to FIG. 2, a second embodiment of a spindle disclosed herein is illustrated at 100B. The two embodiments share several features therefore reference characters common between the two embodiments, although not dimensioned identically provide substantially the same function. One difference between the embodiments is that a shaft 3B of the spindle 100B does not include the coolant supply through-hole 22 (FIG. 1). The front bearing arrangement 43B is similar enough to the front bearing arrangement 43A that a detailed description will not be repeated herein. The rear bearing arrangement 42B, however, differs sufficiently from the rear bearing arrangement 42A that further description is provided hereunder.

Part of this difference is a location of a preloading chamber 20B. In the spindle 100B the preloading chamber 20B is positioned between rear thrust surface 40B of the shaft 3B and plate 41B fixedly attached to rear housing 2B through rear bearing ring 5B. Due to this arrangement fluid flows in a different path in the rear bearing arrangement 42B of the spindle 100B than in the rear bearing arrangement 42A of the spindle 100A. In spindle 100B oil flows from the pockets 7 of the rear journal bearing to the longitudinal preloading chamber 20B through the radial gap 31B and then from the longitudinal preloading chamber 20B through a constant flow restrictor 36 to a return line chamber 24B. This provides a required preloading force for the recess 19. Fluid also flows from the pockets 7 to a return line chamber 26B through a radial gap 30B.

When comparing the two embodiments, the rear bearing arrangement 42B of the spindle 100B has reduced gap surfaces in comparison to the gap surfaces of the rear bearing arrangement 42A of the spindle 100A and as such frictional power losses may be reduced. Additionally, the design of the rear assembly may be less complex and easier to manufacture.

Formulas for Radial and Axial Stiffness Calculations:

The following designations apply:

Ps—Supply pressure

$$( \frac{N}{{m}^{2}} ) ,$$

Hr0—radial gap in the front and rear journal bearings (m),

Ht0—axial gap in the front journal bearing (m),

L1,fr—Length of the radial gap 27 in axial direction (m),

L2,fr—Length of the radial gap 28 in axial direction (m),

L1,r—Length of the radial gap 30 in axial direction (m),

L2,r—Length of the radial gap 31 in axial direction (m),

L3,fr—Width of the gap between pockets 6 in tangential direction for the front journal (m)

L3,r—Width of the gap between pockets 7 in tangential direction for the rear journal (m),

Lk,fr—Length of pockets 6 for the front journal bearing (m),

Lk,r—Length of the pockets 7 for the rear journal bearing (m),

Le,fr—Effective length of pockets 6 for the front journal bearing: Le,fr=Lkfr+0.5 (L1,fr+L2,fr) (m),

Le,r—Effective length of pockets 7 for the rear journal bearing: Le,r=Lk,r+0.5 (L1,r+L2,r) (m),

Dfr—Diameter of the front journal bearing (m),

Dr—Diameter of the rear journal bearing (m),

D1—Internal diameter for gap 29 in the recess 19,

D2—External diameter for the gap 29 in the recess 19,

Sax—Effective surface of the longitudinal recess 19 (m²)

Dpr—Diameter of the preloading chamber 20 (m)

Lpr—Length of the radial gap 32 in the preloading chamber (m)

$$β = \frac{0.33}{0.67 ( 1 + \frac{L 2}{L 1} ) - 0.33}$$

$$α = β \frac{L 2}{L 1}$$

$$δ = α \frac{6 L 1 Le}{π DL 3}$$

$$Sax = 0.25 [ 0.25 {( D 1 + D 2 )}^{2} - {Dfr}^{2} ] ( {m}^{2} )$$

$$Ht 0 = Hr 0 \sqrt[3]{\frac{0.22 ( D 2 - D 1 ) Dfr}{α L 1 , fr ( D 2 + D 1 )}} ( m )$$

The dimensionless parameters β, α and δ have to be calculated separately for the front and rear journal bearings.

Radial stiffness Cr for the front and rear journals:

$$Cr = \frac{4.3 LeD Ps}{Hr 0} \frac{( α + β ) ( β + 0.22 ) - {β}^{2}}{( 1 + α + β + δ ) [ ( 1 + α + β ) ( β + 0.22 ) - {β}^{2} ]}$$

Axial Stiffness Cax:

$$Cax = \frac{3 Ps Sax}{Ht 0} \frac{0.22 β ( 1 + α + β )}{{[ ( 1 + α + β ) ( 0.22 + β ) - {β}^{2} ]}^{2}}$$

Diameter of preloading chamber:

$$Dpr = \sqrt{( {Dr}^{2} + \frac{4 Sax}{π} )}$$

Length of the radial gap for the preloading chamber:

$$Lpr = L 2 , r \frac{Dpr}{Dr}$$

Additionally:

$$Q = \frac{{H}^{3} {L}_{1}}{12 μ {L}_{2}} ( Δ P )$$

Where Q—is a flow through the gap (for example in liters/minute), H-gap height (clearance), L₁—gap width (in direction perpendicular to a flow direction), L₂—gap length (in direction of the flow), μ—dynamic viscosity coefficient for the oil, and ΔP—pressure difference between beginning and end of the gap.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A spindle comprising:
a housing;
a shaft rotatably mounted to the housing;
a first bearing arrangement in operable communication with the housing and the shaft, having at least one first pocket defined between the first bearing arrangement and the shaft forming a first radial hydrostatic bearing and a longitudinal recess between the first bearing arrangement and the shaft forming a first portion of a thrust hydrostatic bearing, fluid supplied to the first portion of the thrust hydrostatic bearing being supplied thereto from the at least one first pocket directly through a first radial gap defined between the first bearing arrangement and the shaft; and
a second bearing arrangement in operable communication with the housing and the shaft, having a longitudinal chamber between the second bearing arrangement and the shaft forming a second portion of the thrust hydrostatic bearing, longitudinal forces on the shaft from the first portion of the thrust hydrostatic bearing and the second portion of the thrust hydrostatic bearing being in opposing directions.

2. The spindle of claim 1, wherein the second bearing arrangement includes at least one second pocket defined between the second bearing arrangement and the shaft forming a second hydrostatic bearing and fluid supplied to the second portion of the thrust hydrostatic bearing is supplied thereto from the at least one second pocket directly through a second radial gap defined between the second bearing arrangement and the shaft.

3. The spindle of claim 1, wherein the first bearing arrangement is comprised of a first ring made of a single piece of material.

4. The spindle of claim 1, wherein the first bearing arrangement includes an air sealing ring in operable communication with the shaft having radial clearances with the shaft that are smaller than radial clearances elsewhere in the first bearing arrangement.

5. The spindle of claim 4, wherein the air sealing ring is made of a low friction material.

6. The spindle of claim 1, further comprising a bushing attached to the shaft and forming a surface of at least one of the first portion and the second portion of the thrust hydrostatic bearing.

7. The spindle of claim 1, further comprising at least one third radial gap between the housing and the shaft on an opposing longitudinal side of the at least one first pocket from the first radial gap, and a longitudinal dimension of the at least one third radial gap is about twice that of the first radial gap.

8. The spindle of claim 7, wherein an inlet gap in the first bearing arrangement is smaller than either of the first gap and the at least one third gap and acts as a filter to fluid that flows therethrough.

9. A shaft and bearing arrangement, comprising:
a housing;
a shaft rotatably engaged with the housing;
a first ring attached to the housing being in operable communication with the shaft and configured to support the shaft in a first longitudinal direction and in radial directions via fluid positioned between the first ring and the shaft; and
a second ring attached to the housing being in operable communication with the shaft and configured to support the shaft in a second longitudinal direction via fluid positioned between the second ring and the shaft.

10. The shaft and bearing arrangement of claim 9, wherein the first longitudinal direction is opposite to the second longitudinal direction.

11. The shaft and bearing arrangement of claim 9, wherein second ring is further configured to support the shaft in radial directions via fluid positioned between the second ring and the shaft.

12. The shaft and bearing arrangement of claim 11, wherein dimensional clearances between the first ring and the shaft are sized to control the positioning of fluid between the first ring and the shaft to provide both the longitudinal support and the radial support to the shaft from the first ring.

13. The shaft and bearing arrangement of claim 12, wherein the longitudinal support and the radial support are such that no contact is made between the first ring and the shaft while the shaft is rotating.

14. The shaft and bearing arrangement of claim 11, wherein dimensional clearances between the second ring and the shaft are sized to control the positioning of fluid between the second ring and the shaft to provide both the longitudinal support and the radial support to the shaft from the second ring.

15. The shaft and bearing arrangement of claim 14, wherein the longitudinal support and the radial support are such that no contact is made between the second ring and the shaft while the shaft is rotating.

16. The shaft and bearing arrangement of claim 11, further comprising at least one air sealing ring in operable communication with the housing and the shaft configured to prevent leakage of fluid therepast.

17. The shaft and bearing arrangement of claim 16, wherein radial clearance between the at least one air sealing ring and the shaft is less than radial clearance between the shaft and at least one of the first ring and the second ring.

18. The shaft and bearing arrangement of claim 11, further comprising a motor positioned between the first ring and the second ring.

19. The shaft and bearing arrangement of claim 18, wherein air sealing rings positioned to either side of the motor prevent fluid between the first ring and the shaft and fluid between the second ring and the shaft from reaching the motor.

20. The shaft and bearing arrangement of claim 11, wherein at least one of the first ring and the second ring are made of a single piece of material.
